(19) United States
(12) Patent Application Publication
(10) Pub. No.: US 2007/0192089 A1
(43) Pub. Date: Aug. 16, 2007

(54) Apparatus and method for reproducing audio data

(76) Inventor: Masahiro Fukuda, Kanagawa (JP)

Correspondence Address: YOUNG & THOMPSON, 745 SOUTH 23RD STREET, 2ND FLOOR, ARLINGTON, VA, 22202, US

(21) Appl. No.: 11/649,226

(22) Filed: Jan. 4, 2007

(30) Foreign Application Priority Data
Jan. 6, 2006 (JP) 2006-001468

(51) Int. Cl. G10L 11/06

(52) U.S. Cl. 704/210

(57) ABSTRACT

In an apparatus for reproducing audio data, a non-silent sound/silent sound determining section determines whether the audio data is a non-silent sound or a silent sound in accordance with a level of the audio data, to thereby generate a first determination result. A speech sound/non-speech sound determining section determines whether the audio data is a speech sound or a non-speech sound in accordance with an absolute value of a difference between left-side and right-side stereochannel component levels of the audio data, to thereby generate a second determination result. An audio data selecting/removing unit selects or removes the audio data in accordance with the first and second determination results.

### BACKGROUND OF THE INVENTION

1. Field of the Invention

The present invention relates to an apparatus and method for reproducing audio data capable of speech speed conversion or capable of reproducing lengthy audio data in a very short time period.

2. Description of the Related Art

In television broadcasting programs, a digital technology for decreasing a speed of speech of an announcer without changing the pitch thereof has been developed, so that elderly people can hear the speech slowly. On the other hand, in a digital audio apparatus, in order to reproduce lengthy audio data in a very short time period, a digital technology for reducing the audio data while maintaining indispensable information of the audio data has been developed.

In the two above-described digital technologies, speech sound time intervals and silent time intervals are discriminated from each other. Then, only audio data in speech sound time intervals is reproduced, and also, reproduction time periods are adjusted to respond to the demand of the listener. In this case, it is important to accurately extract speech sound time intervals.

A first prior art audio data reproducing apparatus (see: JP-2005-128132-A) is constructed by a bandpass filter for attenuating a low frequency component and a high frequency component of decoded audio data to pass only an intermediate frequency component of the decoded audio data therethrough, and a speech speed converting unit for performing a speech speed conversion upon the intermediate frequency component of the decoded audio data. In this case, noise and effect sound (or music sound) included in the decoded audio data are excluded by the bandpass filter. This will be explained later in detail.

A second prior art audio data reproducing apparatus (see: JP-11-120688-A) is constructed by a reproduction buffer for storing decoded audio data from a record medium such as a compact disk (CD), a digital versatile disk (DVD) or a hard disk drive (HDD) in accordance with identification data attached thereto for showing whether the decoded audio data is one in a speech sound time interval or another in a silent time interval (or a music time interval). In this case, the identification data is formed before recording it into the record medium, and the decoded audio data associated with its identification data is recorded into the record medium. This will also be explained later in detail.

### SUMMARY OF THE INVENTION

In the above-described first prior art audio data reproducing apparatus, since the bandpass filter is required, the processing burden is very large. Also, since special decoded audio data associated with identification data is required in advance, the application of the above-described second prior art audio data reproducing apparatus is limited.

According to the present invention, in an apparatus for reproducing audio data, a non-silent sound/silent sound determining section determines whether the audio data is a non-silent sound or a silent sound in accordance with a level of the audio data, to thereby generate a first determination result. A speech sound/non-speech sound determining section determines whether the audio data is a speech sound or a non-speech sound in accordance with an absolute value of a difference between left-side and right-side stereochannel component levels of the audio data, to thereby generate a second determination result. An audio data selecting/removing unit selects or removes the audio data in accordance with the first and second determination results.

Thus, since no bandpass filter is required, the processing burden can be small. Also, since no identification data is required in advance, the application is not limited.

### BRIEF DESCRIPTION OF THE DRAWINGS

The present invention will be more clearly understood from the description set forth below, as compared with the prior art, with reference to the accompanying drawings, wherein:

FIG. 1 is a block circuit diagram illustrating a first prior art audio data reproducing apparatus;

FIGS. 2A, 2B and 2C are timing diagrams for explaining the operation of the audio data reproducing apparatus of FIG. 1;

FIGS. 3A, 3B and 3C are diagrams for explaining the audio data reproducing operation of a second prior art audio data reproducing apparatus;

FIG. 4 is a block circuit diagram illustrating a first embodiment of the audio data reproducing apparatus according to the present invention;

FIGS. 5A, 5B and 5C are timing diagrams for explaining the operation of the frame determining unit of FIG. 4;

FIG. 6 is a table showing priorities of frames of FIG. 4;

FIG. 7 is a timing diagram for explaining the operation of the frame selecting/removing unit of FIG. 4;

FIG. 8 is a block circuit diagram illustrating a second embodiment of the audio data reproducing apparatus according to the present invention; and

FIGS. 9, 10 and 11 are flowcharts for explaining the operation of the audio data reproducing apparatus of FIG. 8.

### DESCRIPTION OF THE PREFERRED EMBODIMENTS

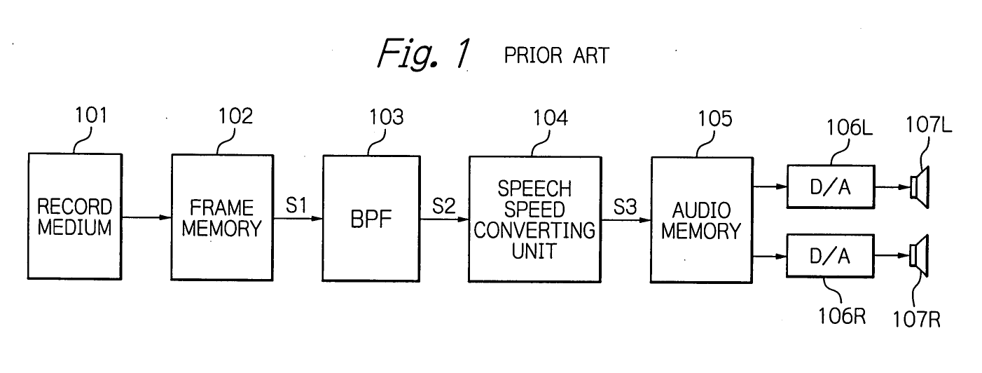

Before the description of the preferred embodiments, prior art audio data reproducing apparatuses will be explained with reference to FIGS. 1, 2A, 2B, 2C, 3A, 3B and 3C.

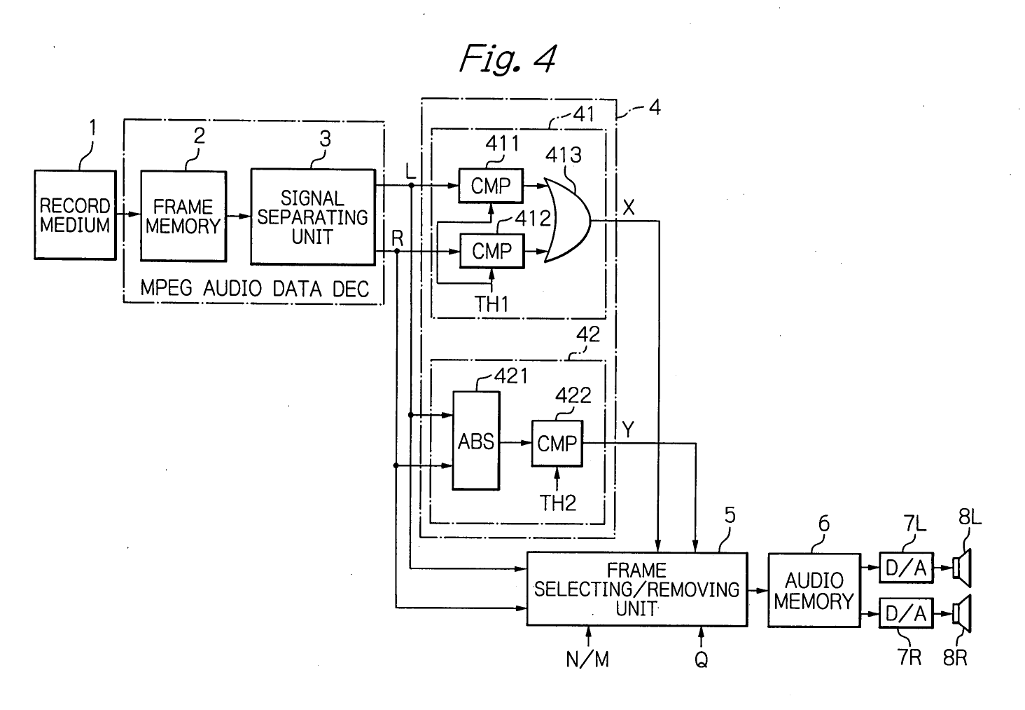

In FIG. 1, which illustrates a first prior art audio data reproducing apparatus (see: FIGS. 1 and 4 of JP-2005-128132-A), reference numeral 101 designates a record medium such as a compact disk (CD), a digital versatile disk (DVD) or a hard disk drive (HDD), 102 designates a frame memory for storing one frame of decoded audio data read in bursts from the record medium 101, 103 designates a bandpass filter for attenuating a low frequency component and a high frequency component of the decoded audio data to pass only an intermediate frequency component of the decoded audio data therethrough, 104 designates a speech speed converting unit for performing a speech speed conversion upon the intermediate frequency component of the decoded audio data, 105 designates an audio memory for storing the decoded audio data passed from the speech speed converting unit 104, 106L and 106R designate digital/analog (D/A) converters for performing D/A conversions upon the left-side and right-side output signals, respectively, of the audio memory 105, and 107L and 107R designate a left-side speaker and a right-side speaker, respectively, for reproducing left-side and right-side analog output signals, respectively, from the D/A converters 106L and 106R.

Note that the byte length of one frame stored in the frame memory 102 is defined by the Moving Picture Experts Group (MPEG) standard.

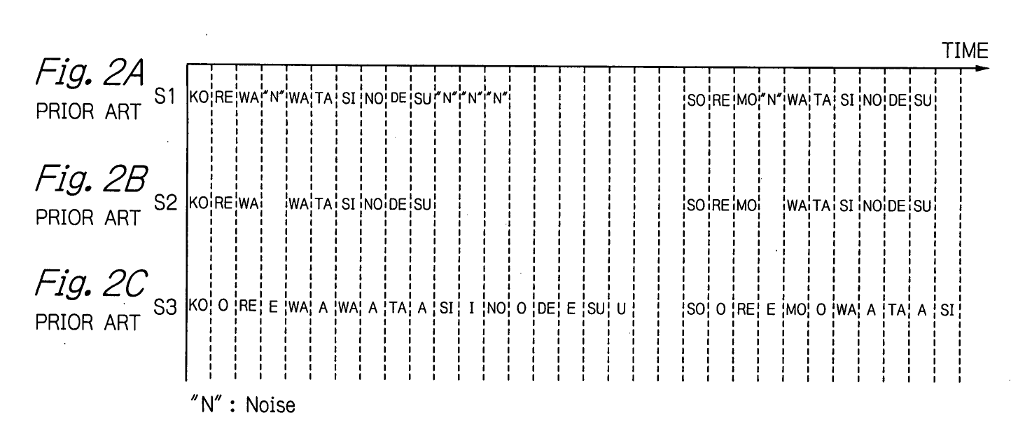

In the audio data reproducing apparatus of FIG. 1, if an audio data signal S1 from the frame memory 102 is defined as shown in FIG. 2A, noise N and effect sound (or music sound) included in the audio data signal S1 are excluded by the bandpass filter 103, so that the bandpass filter 103 generates an audio data signal S2 as shown in FIG. 2B. In the speech speed converting unit 104, silent time intervals are separated from the audio data signal S1, and one vowel is extracted from each speech sound time interval of the audio data signal S2 and is added thereto to extend the speech sound time interval. Thus, the speech speed converting unit 104 generates a time-extended audio data signal S3 as shown in FIG. 2C without changing the pitch of the audio data signal S1.

In the audio data reproducing apparatus of FIG. 1, however, since the bandpass filter 103 is required, the processing burden is very large.

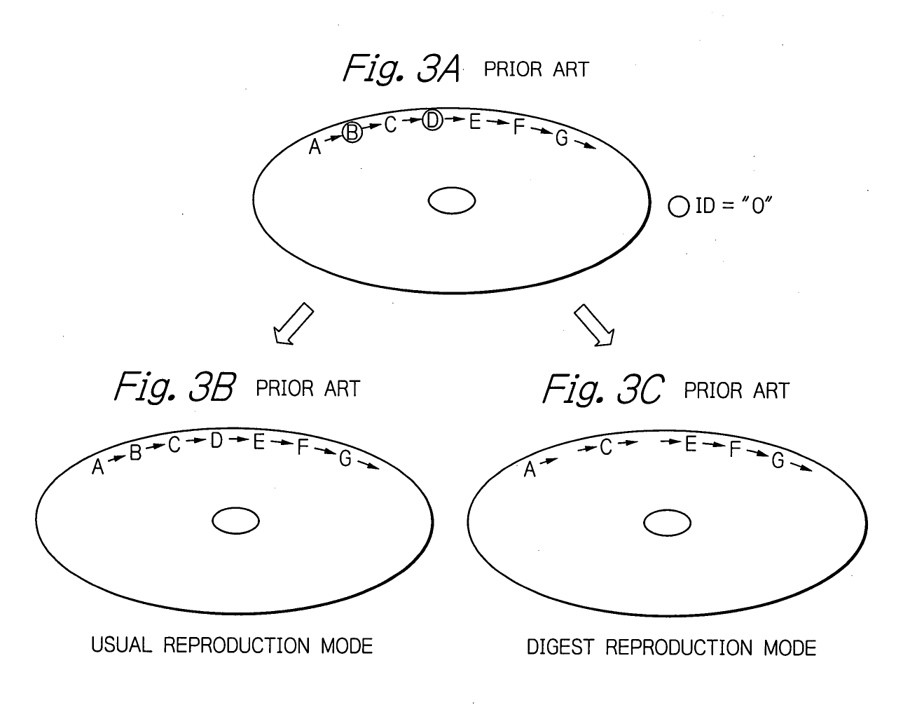

FIGS. 3A, 3B and 3C are diagrams for explaining the audio data reproducing operation of a second prior art audio data reproducing apparatus (see: JP-11-120688-A).

As shown in FIG. 3A, before recording audio data into a record medium, it is determined the audio data belongs to a speech sound time interval or a silent time interval (or a musical time interval). Then, the audio data associated with identification data ID showing whether the audio data belongs to a speech sound time interval or a silent time interval (or a musical time interval) is recorded into the record medium. In FIG. 3A, audio data A, C, E, F, G . . . associated with ID (=“1”) belong to speech sound time intervals, while audio data B, D, . . . associated with ID (=“0”) belong to silent time intervals (musical time intervals).

When reproducing the audio data as shown in FIG. 3A in a usual reproduction mode, the audio data A, B, C, D, E, F, G . . . regardless of their identification data ID are read in bursts from the record medium.

When reproducing the audio data as shown in FIG. 3A in a digest reproduction mode, the audio data A, C, E, F, G . . . having identification data ID (=“1”) are read in bursts from the record medium.

In the audio data reproducing apparatus for carrying out the audio data reproducing operation as shown in FIGS. 3A, 3B and 3C, however, since specific audio data associated with identification data ID is required in advance, the application is limited.

In FIG. 4, which illustrates a first embodiment of the audio data reproducing apparatus according to the present invention, audio data is read in bursts from a record medium 1 such as a CD, a DVD or an HDD to a frame memory 2 for storing one frame of the audio data which is separated by a signal separating unit 3 into stereochannel signals L and R. Note that the frame memory 2 and the signal separating unit 3 are a part of an MPEG audio data decoder, for example.

A frame determining unit 4 is constructed by a non-silent sound/silent sound determining section 41 and a speech sound/music sound determining section 42.

The non-silent sound/silent sound determining section 41 receives the stereochannel signals L and R from the signal separating unit 3 to determine whether the stereochannel signals L and R show a non-silent sound or a silent sound.

The non-silent sound/silent sound determining section 41 is constructed by a comparator 411 for comparing a peak value or an average square value of one frame of the stereochannel signal L with a threshold value TH1, a comparator 412 for comparing a peak value or an average square value of one frame of the stereochannel signal R with the threshold value TH1, and an OR circuit 413 connected to outputs of the comparators 411 and 412 to generate a determination result X. The threshold value TH1 is supplied from a control circuit (not shown) such as a central processing unit (CPU). In this case, if L and R also represent a peak value or an average square value of one frame, when L>TH1 or R>TH1, X=“1” (non-silent sound). On the other hand, when L≦TH1 and R≦TH1, X=“0” (silent sound).

Also, the speech sound/music sound determining section 42 receives the stereochannel signals L and R from the signal separating unit 3 to determine whether the stereochannel signals L and R show a speech sound or a non-speech sound (music sound or surrounding noise).

The speech sound/non-speech sound determining section 42 is constructed by an absolute value calculating unit 421 for calculating an absolute value ABS of a difference in peak value or average square value in one frame between the stereochannel signals L and R, and a comparator 422 for comparing the absolute value ABS with a threshold value TH2 to generate a determination result Y. The threshold value TH2 is supplied from the control circuit (not shown). In this case, when ABS<TH2, Y=“1” (speech sound). On the other hand, when ABS≧TH2, Y=“0” (non-speech sound).

A frame selecting/removing unit 5 removes frames in accordance with a unit frame number M (M=2, 3, . . . ), a selected frame number N (N=1, 2, . . . and N<M) and the determination pairs (X, Y) of the frame determining unit 4. In this case, the frame selecting/removing unit 5 has M buffers for storing M frames. The frame selecting/removing unit 5 transmits the selected frames to an audio memory 6 at a reproduction speed Q which is also supplied from the control circuit (not shown).

The audio memory 6 stores the selected frames and transmits them via D/A converters 7L and 7R to speakers 8L and 8R, respectively.

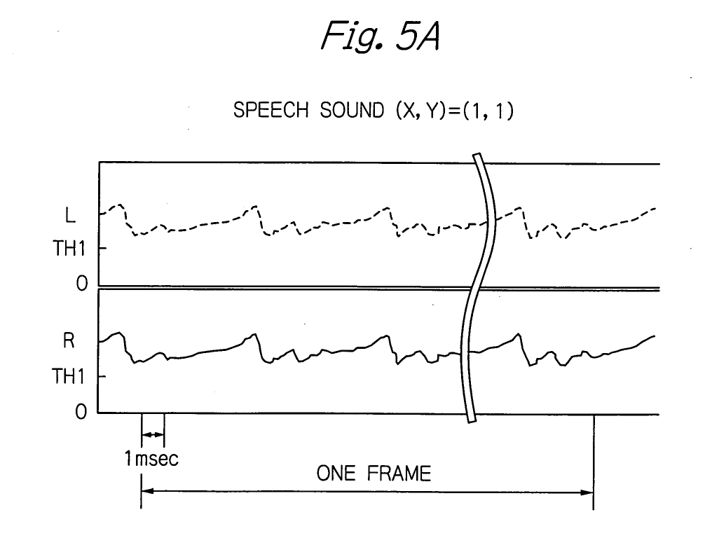

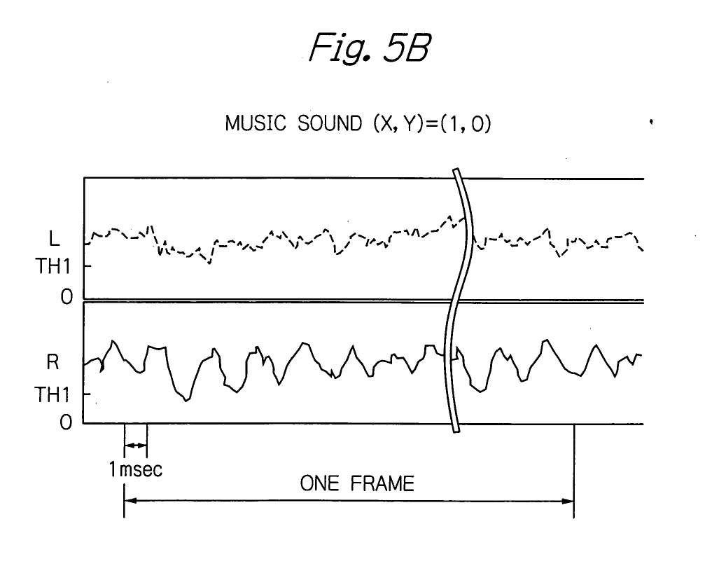

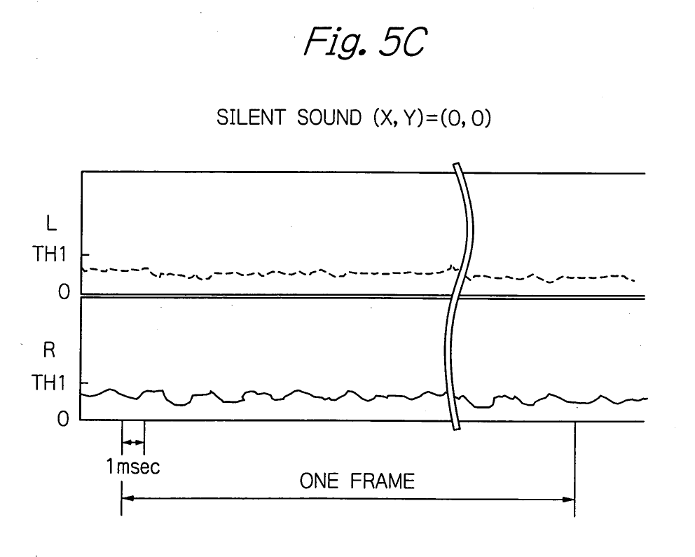

The determination pairs (X, Y) of the frame determining unit 4 are explained with reference to FIGS. 5A, 5B and 5C.

As shown in FIG. 5A, when the audio data is a speech sound, the peak value or average square value of the stereochannel signals L and R are much higher than the threshold value TH1, so that the output signals of the comparators 411 and 412 are “1” (high level). Therefore, the determination result X is “1”. On the other hand, since the stereochannel signals L and R are similar to each other, the difference therebetween is almost zero, so that the absolute value thereof is almost zero (<TH2). Thus, the determination result Y is “1” (high level).

As shown in FIG. 5B, when the audio data is a music sound, the peak value or average square value of the stereochannel signals L and R is also much higher than the threshold value TH1, so that the output signals of the comparators 411 and 412 are “1” (high level). Therefore, the determination result X is “1”. On the other hand, since the stereochannel signals L and R are different from each other, the difference therebetween is not zero and is relatively large, so that the absolute value thereof is relatively large (>TH2). Thus, the determination result Y is “0” (low level).

As shown in FIG. 5C, when the audio data is a silent sound (or noise), the peak value or average square value of the stereochannel signals L and R is much lower than the threshold value TH1, so that the output signals of the comparators 411 and 412 is “0” (low level). Therefore, the determination result X is “0”. On the other hand, the difference in the stereochannel signals L and R depends upon the silent sound or noise, so that the absolute value thereof depends upon the silent sound or noise. Thus, the determination result Y may be “1” (high level) or “0” (low level).

Note that the peak value or average square value of the stereochannel signals L and R can be calculated based on the overall frames or parts such as 1 msec thereof as shown in FIGS. 5A, 5B and 5C.

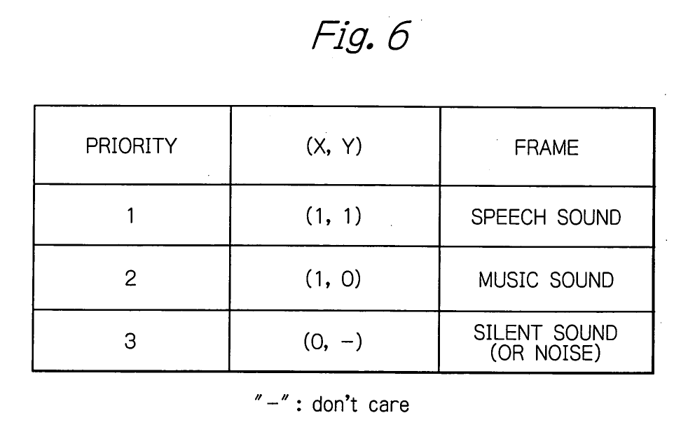

The frame selecting/removing unit 5 selects and removes the frames stored in the buffers therein in accordance with the priorities of the frames as shown in FIG. 6. That is, speech sound frames whose determination pairs (X, Y) are (1, 1) have priority 1. Also, music sound frames whose determination pairs (X, Y) are (1, 0) have priority 2. Further, silent sound frames including noise frames whose determination pairs (X, Y) are (0, -) where - indicates “don't care”.

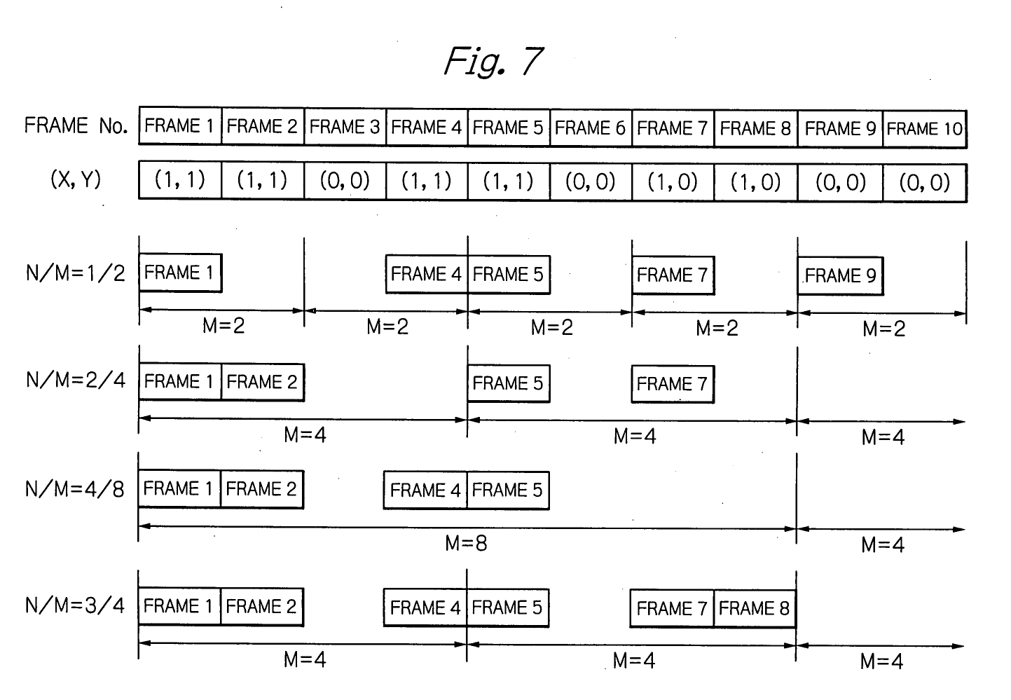

The operation of the frame selecting/removing unit 5 of FIG. 4 is explained next with reference to FIG. 7.

Frames 1, 2, . . . are transmitted in bursts from the frame memory 2 and the signal separating unit 3 to the frame selecting/removing unit 5. In this case, since the frames 1, 2, 4, 5, . . . have determination pairs (X, Y)=(1, 1), the frames 1, 2, 4, 5, . . . are speech sound frames. Also, since the frames 7, 8, . . . have determination pairs (X, Y)=(1, 0), the frames 7, 8, . . . are music sound frames. Further, since the frames 3, 6, 9, 10, . . . have determination pairs (X, Y)=(0, 0), the frames 3, 6, 9, 10, . . . are silent sound frames including noise frames.

Assume that M=2 and N=1. In this case, the frame selecting/removing unit 5 selects one frame from every two successive frames, i.e., removes one frame from every two successive frames. For example, as to the frames 1 and 2, since the frames 1 and 2 have highest priority determination pairs (X, Y)=(1, 1), the first frame 1 of the two frames is selected and the second frame 2 of the two frames is removed. As to the frames 3 and 4, since the frame 4 has a higher priority determination pair (X, Y)=(1, 1) than the determination pair (X, Y)=(0, 0) of the frame 3, the frame 4 is selected and the frame 3 is removed.

Assume that M=4 and N=2. In this case, the frame selecting/removing unit 5 selects two frames from every four successive frames, i.e., removes two frames from every four successive frames. For example, as to the frames 1, 2, 3 and 4, since the three frames 1, 2 and 4 have highest priority determination pairs (X, Y)=(1, 1) and the frame 3 has a lowest priority determination pair (X, Y)=(0,0), the first two frames 1 and 2 of the three frames are selected and the last frame 3 of the three frames and the frame 4 are removed. Also, as to the frames 5, 6, 7 and 8, since the frame 5 has a highest priority determination pair (X, Y)=(1, 1) and the two frames 7 and 8 have second highest priority determination pairs (X, Y)=(1, 0), the frame 5 and the first frame 7 of the frames 7 and 8 are selected and the frame 6 and the second frame 8 of the two frames 7 and 8 are removed.

Assume that M=8 and N=4. In this case, the frame selecting/removing unit 5 selects four frames from every eight successive frames, i.e., removes four frames from every eight successive frames. For example, as to the frames 1, 2, 3, 4, 5, 6, 7 and 8, since the frames 1, 2, 4 and 5 have highest priority determination pairs (X, Y)=(1, 1), the frames 1, 2, 4 and 5 are selected and the frames 3, 6, 7 and 8 are removed.

Assume that M=4 and N=3. In this case, the frame selecting/removing unit 5 selects three frames from every four successive frames, i.e., removes one frame from every four successive frames. For example, as to the frames 1, 2, 3 and 4, since the frames 1, 2 and 4 have highest priority determination pairs (X, Y)=(1, 1) and the frame 3 has a lowest priority determination pair (X, Y)=(0,0), the frames 1, 2 and 4 are selected and the frame 3 is removed. Also, as to the frames 5, 6, 7 and 8, since the frame 5 has a highest priority determination pair (X, Y)=(1, 1) and the frames 7 and 8 have second highest priority determination pair (X, Y)=(1, 0), the frames 5, 7 and 8 are selected and the frame 6 is removed.

Thus, the frame selecting/removing unit 5 selects N frames from every M successive frames in accordance with the determination pairs (X, Y) of the frames and removes the other (M-N) non-selected frames from every M successive frames.

Simultaneously, the frame selecting/removing unit 5 transmits the selected frames to the audio memory 6 at the reproduction speed Q. For example, if N/M=½, the video data (not shown) are reproduced at a reproduction speed 2Q and the selected frames (audio data) are reproduced at a reproduction speed Q. As a result, the reproduced video data are synchronized with the reproduced audio data.

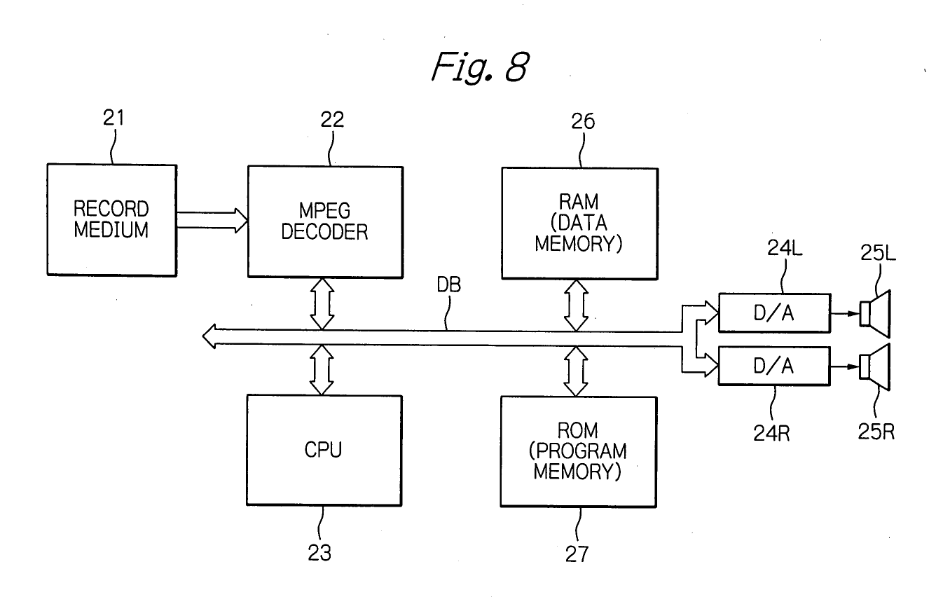

In FIG. 8, which illustrates a second embodiment of the audio data reproducing apparatus according to the present invention, a record medium 21 corresponding to the record medium 1 of FIG. 4 supplies audio data to an MPEG decoder 22 corresponding to the frame memory 2 and the signal separating unit 3 of FIG. 4. The MPEG decoder 22 is connected via a data bus DB to a central processing unit (CPU) 23 which corresponds to the frame determining unit 4 and the frame selecting/removing unit 5 of FIG. 4. Also, D/A converters 24L and 24R corresponding to the D/A converters 7L and 7R of FIG. 4 and speakers 25L and 25R corresponding to the speakers 8L and 8R of FIG. 4 are connected to the data bus DB.

Further, a random access memory (RAM) 26 called a data memory for temporarily storing data for the CPU 23 and a read only memory (ROM) 27 called a program memory for storing programs for the CPU 23 are connected to the data bus DB. Note that the RAM 26 also serves as the audio memory 6 of FIG. 4.

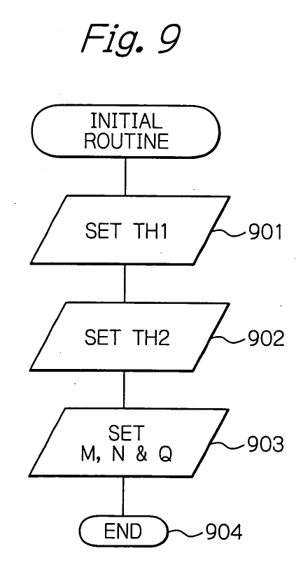

The operation of the audio data reproducing apparatus of FIG. 8, particularly, the operation of the CPU 23 of FIG. 8 is explained next with reference to FIGS. 9, 10 and 11.

FIG. 9 is an initial routine.

First, referring to step 901, a threshold value TH1 is set by an input unit (not shown) in the RAM 26.

Next, referring to step 902, a threshold value TH2 is set by the input unit in the RAM 26.

Next, referring to step 903, a unit frame number M, a selected frame number N and a reproduction speed Q are set by the input unit in the RAM 26.

The routine of FIG. 9 is completed by step 904.

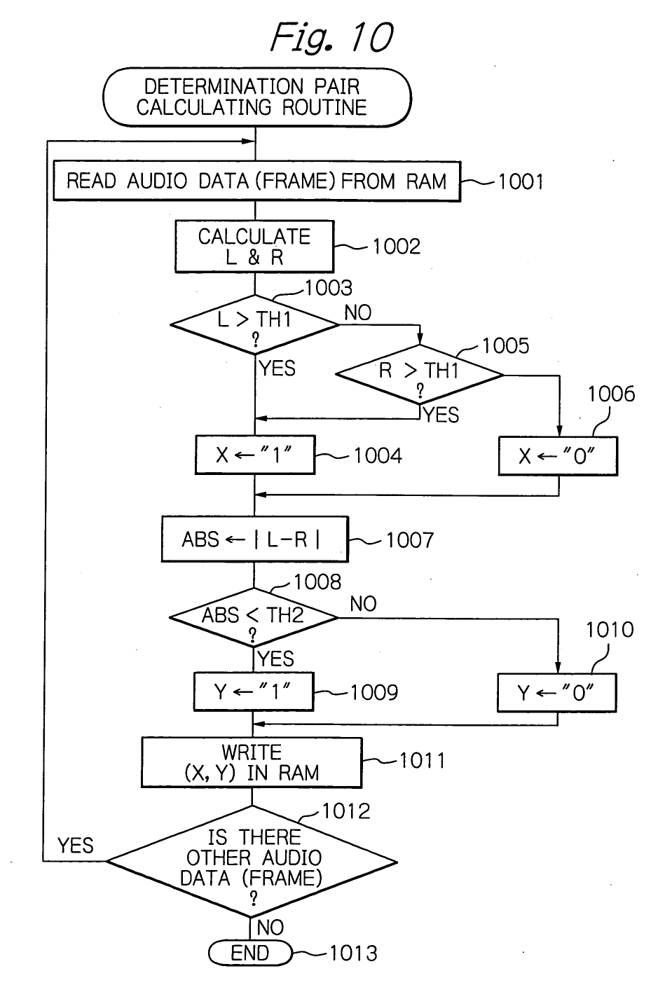

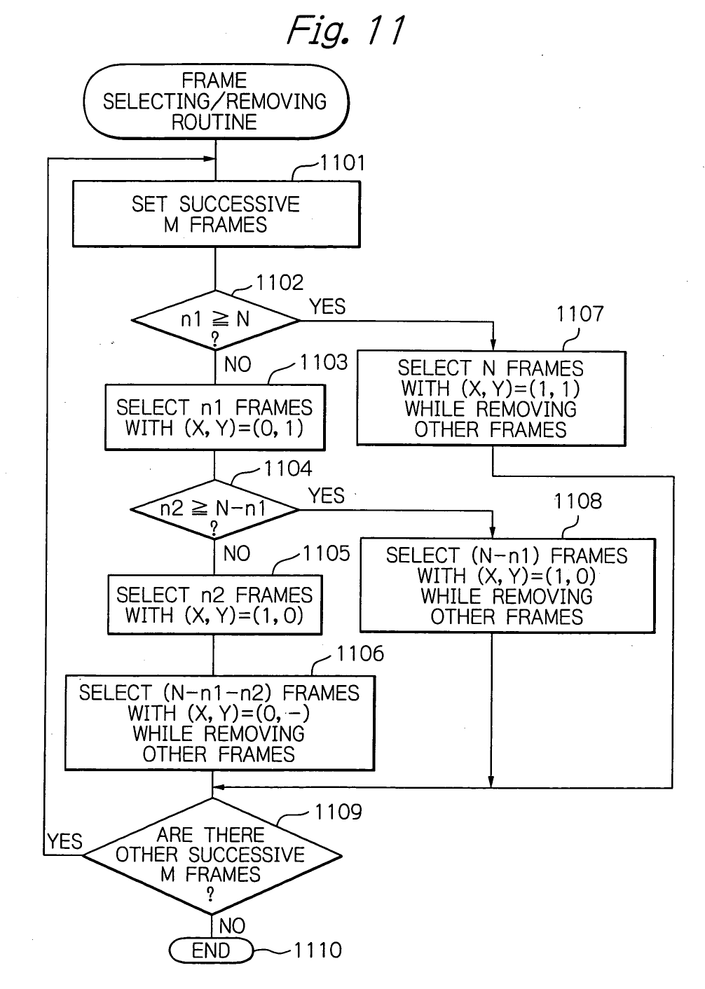

FIG. 10 is a routine for calculating determination pairs (X, Y) of audio data (frames). Here, assume that audio data as frames are read in bursts by the MPEG decoder 22 from the record medium 21, and then, the CPU 23 writes the frames into the RAM 26.

First, referring to step 1001, the CPU 23 reads audio data (one frame) from the RAM 26.

Next, referring to step 1002, the CPU 23 calculates a peak value or an average square value of the stereochannel signal L of the read audio data. Note that this peak value or average square value is also defined by L. Also, the CPU 23 calculates a peak value or an average square value of the stereochannel signal R of the read audio data. Note that this peak value or average square value is also defined by R.

Note that the peak values or average square values of the stereochannel signals L and R can be calculated based upon the entire read audio data or parts thereof corresponding to 1 msec audio data.

Next, referring to step 1003, it is determined whether or not L>TH1 is satisfied. Only when L>TH1 is satisfied, does the control proceed to step 1004 which causes a determination result X to be “1”. Otherwise, the control proceeds to step 1005.

Referring to step 1005, it is determined whether or not R>TH1 is satisfied. Only when R>TH1 is satisfied, does the control proceed to step 1004 which causes the determination result X to be “1”. Otherwise, the control proceeds to step 1006 which causes the determination result X to be “0”.

Thus, when L>TH1 or R>TH1, the determination result X is caused to be “1” by step 1004. On the other hand, when L<TH1 and R<TH1, the determination result X is caused to be “0” by step 1006.

Next, referring to step 1007, an absolute value ABS of a difference between the peak value or average square value L and the peak value or average square value R is calculated.

Next, referring to step 1008, it is determined whether or not ABS<TH2 is satisfied. Only when ABS<TH2, does the control proceed to step 1009 which causes a determination result Y to be “1”. Otherwise, the control proceeds to step 1010 which causes the determination result Y to be “0”.

Next, referring to step 1011, the CPU 23 writes the determination pairs (X, Y) in the RAM 26 in correspondence with the read audio data (frame).

Steps 1001 to 1011 are repeated by step 1012 until there is no audio data (frame) which needs a determination pair.

The routine of FIG. 10 is completed by step 1013.

FIG. 11 is a routine for selecting/removing audio data (frames).

First, referring to step 1101, the CPU 23 set successive M frames from the RAM 26.

Next, referring to step 1102, it is determined whether or not the following is satisfied:
n1≧N
where n1 is a number of first priority frames with (X, Y)=(1, 1) within the M frames. When n1≧N, the control proceeds to step 1107 which selects N frames with (X, Y)=(1, 1) on a time basis while removing the other frames. For example, in FIG. 7 where N/M= 2/4, the frames 1 and 2 are selected while the frame 4 as well as the frame 3 is removed. On the other hand, when n1<N, the control proceeds to step 1103 which selects all the n1 frames with (X, Y)=(1, 1). For example, in FIG. 7 where N/M= 2/4, the frame 5 with (X, Y)=(1, 1) is selected. The control at step 1103 proceeds to step 1104.

Next, referring to step 1104, it is determined whether the following is satisfied:
n2>N−n1

where n2 is a number of second priority frames with (X, Y)=(1, 0). When n2≧N−n1, the control proceeds to step 1108 which selects (N−n1) frames with (X, Y)=(1, 0) on a time basis while removing the other frames. For example, in FIG. 7 where N/M= 2/4, the frame 7 is selected while the frame 8 as well as the frame 6 is removed. On the other hand, when n2<N−n1, the control proceeds to step 1105 which selects all the n2 frames with (X, Y)=(1, 0). For example, in FIG. 7 where N/M=¾, the frames 7 and 8 are selected. The control at step 1105 proceeds to step 1106.

Next, referring to step 1106, (N−n1−n2) lowest priority frames with (X, Y)=(0, -) are selected on a time basis while the other frames are removed. For example, in FIG. 7 where N/M=½, the frame 9 is selected while the frame 10 is removed.

Steps 1101 to 1108 are repeated by step 1109 until there are no successive M frames.

The routine of FIG. 11 is completed by step 1110.

In the second embodiment of FIG. 8, the CPU 23 transmits the frames selected by the routine of FIG. 11 to the D/A converters 24L and 24R at the reproduction speed Q, so that the frames (audio data) can be reproduced at the speakers 25L and 25R.

Note that the determination pair calculating routine of FIG. 10 and the frame selecting/removing routine of FIG. 11 are carried out in parallel.

1. An apparatus for reproducing audio data comprising:
a non-silent sound/silent sound determining section adapted to determine whether said audio data is a non-silent sound or a silent sound in accordance with a level of said audio data, to thereby generate a first determination result;
a speech sound/non-speech sound determining section adapted to determine whether said audio data is a speech sound or a non-speech sound in accordance with an absolute value of a difference between left-side and right-side stereochannel component levels of said audio data, to thereby generate a second determination result; and
an audio data selecting/removing unit adapted to select or remove said audio data in accordance with said first and second determination results.

2. The apparatus as set forth in claim 1, wherein said non-silent sound/silent sound determination unit comprises:
a first comparator adapted to compare the left-side stereochannel component level of said audio data with a first threshold value;
a second comparator adapted to compare the right-side stereochannel component level of said audio data with said first threshold value; and
a logic circuit connected to outputs of said first and second comparators, said logic circuit being adapted to generate said first determination result.

3. The apparatus as set forth in claim 1, wherein said speech sound/non-speech sound determining section comprises:
an absolute value calculating unit adapted to calculate the absolute value of the difference between the left-side and right-side stereochannel component levels of said audio data; and
a third comparator connected to said absolute value calculating circuit, said third comparator being adapted to compare the absolute value with a second threshold value, to thereby generate said second determination result.

4. The apparatus as set forth in claim 1, wherein the level of said audio data is one of a peak value and an average square value of at least part of said audio data.

5. An apparatus for reproducing a plurality of M frames (M=2, 3, . . . ) audio data comprising:
a non-silent sound/silent sound determining section adapted to determine whether each of said M frames is a non-silent sound or a silent sound in accordance with left-side and right-side stereochannel component levels of said each of said M frames, to thereby generate a first determination result;
a speech sound/non-speech sound determining section adapted to determine whether each of said frames is a speech sound or a non-speech sound in accordance with an absolute value of a difference between the left-side and right-side stereochannel component levels of said each of said M frames, to thereby generate a second determination result; and
a frame selecting/removing unit adapted to select N frames (N=1, 2, . . . and N<M) from said M frames and remove (M-N) frames from said M frames in accordance with pairs of said first and second determination results of said M frames, thus reproducing only said N frames.

6. The apparatus as set forth in claim 5, wherein the pairs of said first and second determination results have priorities so that a pair of said first and second determination results showing said non-silent sound and said speech sound, respectively, have a highest priority; a pair of said first and second determination results showing said non-silent sound and said non-speech sound, respectively, have a second highest priority; and a pair of said first and second determination results where said first determination result show said silent sound have a lowest priority.

7. The apparatus as set forth in claim 5, wherein said non-silent sound/silent sound determination unit comprises:
a first comparator adapted to compare the left-side stereochannel component level of said audio data with a first threshold value;
a second comparator adapted to compare the right-side stereochannel component level of said audio data with said first threshold value; and
a logic circuit connected to outputs of said first and second comparators, said logic circuit being adapted to generate said first determination result.

8. The apparatus as set forth in claim 5, wherein said speech sound/non-speech sound determining section comprises:
an absolute value calculating unit adapted to calculate the absolute value of the difference between the left-side and right-side stereochannel component levels of said audio data; and
a third comparator connected to said absolute value calculating circuit, said third comparator being adapted to compare the absolute value with a second threshold value, to thereby generate said second determination result.

9. The apparatus as set forth in claim 5, wherein the level of said audio data is one of a peak value and an average square value of at least part of said audio data.

10. A method for reproducing audio data comprising:
determining whether said audio data is a non-silent sound or a silent sound in accordance with a level of said audio data, to thereby generate a first determination result;
determining whether said audio data is a speech sound or a non-speech sound in accordance with an absolute value of a difference between left-side and right-side stereochannel component levels of said audio data, to thereby generate a second determination result; and
selecting or removing said audio data in accordance with said first and second determination results.

11. The method as set forth in claim 10, wherein said non-silent sound/silent sound determination comprises:
comparing the left-side stereochannel component level of said audio data with a first threshold value to generate a first comparison result;
comparing the right-side stereochannel component level of said audio data with said first threshold value to generate a second comparison result; and performing a logic operation upon said first and second comparison results to generate said first determination result.

12. The method as set forth in claim 10, wherein said speech sound/non-speech sound determining comprises:
calculating the absolute value of the difference between the left-side and right-side stereochannel component levels of said audio data; and
comparing the absolute value with a second threshold value, to thereby generate said second determination result.

13. The method as set forth in claim 10, wherein the level of said audio data is one of a peak value and an average square value of at least part of said audio data.

14. A method for reproducing a plurality of M frames (M=2, 3, . . . ) audio data comprising:
determining whether each of said M frames is a non-silent sound or a silent sound in accordance with left-side and right-side stereochannel component levels of said each of said M frames, to thereby generate a first determination result;
determining whether each of said frames is a speech sound or a non-speech sound in accordance with an absolute value of a difference between the left-side and right-side stereochannel component levels of said each of said M frames, to thereby generate a second determination result; and
selecting N frames (N=1, 2, . . . and N<M) from said M frames and removing (M-N) frames from said M frames in accordance with pairs of said first and second determination results of said M frames, thus reproducing only said N frames.

15. The method as set forth in claim 14, wherein the pairs of said first and second determination results have priorities so that a pair of said first and second determination results showing said non-silent sound and said speech sound, respectively, have a highest priority; a pair of said first and second determination results showing said non-silent sound and said non-speech sound, respectively, have a second highest priority; and a pair of said first and second determination results where said first determination result show said silent sound have a lowest priority.

16. The method as set forth in claim 14, wherein said non-silent sound/silent sound determination comprises:
comparing the left-side stereochannel component level of said audio data with a first threshold value to generated a first comparison result;
comparing the right-side stereochannel component level of said audio data with said first threshold value to generate a second comparison result; and
performing a logic operation upon said first and second comparison results to generate said first determination result.

17. The apparatus as set forth in claim 14, wherein said speech sound/non-speech sound determining comprises:
calculating the absolute value of the difference between the left-side and right-side stereochannel component levels of said audio data; and
comparing the absolute value with a second threshold value, to thereby generate said second determination result.

18. The method as set forth in claim 14, wherein the level of said audio data is one of a peak value and an average square value of at least part of said audio data.
